(19) United States
(12) Patent Application Publication
(10) Pub. No.: US 2004/0200925 A1
(43) Pub. Date: Oct. 14, 2004

(54) Cavitating oil hyperspace energy generator

(76) Inventor: John Quincy St.Clair, San Juan, PR (US)

Correspondence Address: John St.Clair, Hyperspace Research Institute, 52 Kings Court, 4A, San Juan, PR, 00911, US

(21) Appl. No.: 10/372,557

(22) Filed: Feb. 21, 2003

(51) Int. Cl. B64C 27/22

(52) U.S. Cl. 244/10

(57) ABSTRACT

A hyperspace energy generator that uses cavitating oil bubbles within a magnetic field in order to create wormholes between space and hyperspace for the purpose of permeating the hull of a spacecraft with low-density hyperspace energy.

### BRIEF SUMMARY OF THE INVENTION

This invention is a hyperspace energy generator that uses cavitating oil bubbles within a magnetic field in order to create wormholes between space and hyperspace for the purpose of permeating the hull of a spacecraft with low-density, low-speed-of-light hyperspace energy.

### BACKGROUND OF THE INVENTION

As shown by physicist Dr. John Archibald Wheeler of Princeton University, there is a second term in Newton's gravitational equation which includes an additional force depending on whether or not the body is spinning.

F=mg+m(v×Ω)

where F is the force, m the mass, g the acceleration of gravity, v the forward velocity of the body, and Ω the angular velocity of the body. Referring to FIG. 1, a rotating cylinder (A) is moving with a velocity (B) while spinning counterclockwise as shown by the angular velocity vector (C). The velocity crossed with the angular velocity vector produces a force in the upward direction (D).

Referring to FIG. 2, a pendulum (A) held in the left hand over the right hand will spin in the counterclockwise direction due to the hyperspace energy vortex (B) emanating from the palm of the right hand. This vortex arises because human beings are hyperspace energy beings that live in physical containers located in this universe. The vortex might be considered a wormhole between space and hyperspace. Notice that the angular momentum vector of the vortex points up out of the palm of the hand. If the hand were spinning from left to right, then there would be a force exerted, as shown by the above equation, that would bring hyperspace energy into the right arm.

Referring to FIG. 3, in order to test this hypothesis, a Chakra Vortex Accelerator was built for the purpose of spinning this hand vortex. The motor-driven machine has a base (A) on which is mounted a warehouse palletizing ring and platform (B). A control column (C) has a speed control and on/off switch. A person (D) stands on the platform with his right arm outstretched and palm facing upward (E). The platform spins from left to right.

Referring to FIG. 4, the velocity vector (A) points to the right. The angular momentum vector of the rotating chakra energy vortex points up. The cross product A×B=C produces a force that brings in high permeability hyperspace energy into the arm.

Referring to FIG. 5, after spinning 99 times per day for a few months, it was noticed that the right arm (A) would remain out at an angle φ from the body without making any exertion to do so. The left arm, which was not receiving the energy, remained at the side of the body. That is, the low-density hyperspace energy in the right arm was making the arm lighter and producing a subsequent antigravitational effect. The conclusion was that it might be possible to invent some device which would produce large amounts of hyperspace energy. This would make possible relativistic electromagnetic fields which can be used to produce the lift force for electromagnetic field propulsion vehicles.

Then in the February 1995 issue of Scientific American, an article appeared entitled Producing Light from a Bubble of Air which gave the details for producing sonoluminescence from a cavitating bubble using a kit for sale containing the piezoelectric transducers. Referring to FIG. 6, the experimental setup includes a ring stand (A) with a three-finger clamp (B) holding a 100 milliliter flask containing degassed water produced by a Walsh vacuum/pressure pump. Piezoelectric drive transducers (D) are mounted on the sides of the flask in order to create sound pressure waves which create the cavitation bubble (M) in the center of the flask. The transducers are connected by insulated wire (I) to a pair of inductors (E) having a mutual inductance between them. These inductors are driven by a frequency generator (H) connected to an audio amplifier (G). The oscillation signals are picked up by the oscilloscope (J) which is connected to the resistors (F) using the probes (K). The piezoelectric drive transducers act electrically as capacitors. The inductors are wired in series with the capacitance such that the combination resonates at the frequency at which acoustic resonance occurs. Bubbles introduced into the flask tend to coalesce in the center of the flask Above a certain sound intensity, the bubble will collapse and emit a dim light visible to the unaided eye in a darkened room, a process called sonoluminescence.

Further research showed that there were some earlier doctoral theses available. One of them by Dr. Steven DeWitt Horsburgh entitled Radial Instabilities of a pulsating air bubble in water mentioned a most interesting observed phenomenon of the surface oscillations called a “beaconing effect.” When a bubble exhibited a stable or long-lived shape oscillation lasting more than two minutes, the bubble had a tendency to slowly precess. The precession rate was on the order of a few hertz which can be taken to mean around 3 Hz. Visually, the beacon looked like a light house beacon. It was a very obvious effect and when the beacon crossed the photodiode, the output voltage increased by at least an order of magnitude.

Upon reading this, it became apparent that sonoluminescence is involved with gravitational hyperspace physics. Einstein's theory says that inertia is a manifestation of the geometry of spacetime. It also says that geometry is affected by the presence of matter to an extent proportional to the factor G/c² where G is the gravitational constant and c is the speed of light. The inverse of this factor is the linear mass Ω of the universe. A spherical shell of mass m with a radius R will create a drag angular velocity on a pendulum equal to

$${ω}_{drag} = \frac{4}{3} \frac{G}{{c}^{2}} \frac{{m}_{shell}}{{R}_{shell}} {ω}_{shell} = \frac{4}{3} \frac{\frac{{m}_{shell}}{Ω}}{{R}_{shell}} {ω}_{shell}$$

The mass of the shell divided by the linear mass (mass per length) converts the mass into a length which is then divided by the radius of the shell which is also a length. The numerical factor 4/3 is found only by a detailed calculation. The calculation, starting from a flat background spacetime manifold, showed the effect of the moving current of mass on the metric. Expressed in polar coordinates, the metric acquires a non-zero coefficient g_{φt}. Inserted into the equation for geodesic motion, this off-diagonal metric coefficient gives rise to a precession according to the above equation. The numerical factor corresponds to a pendulum located anywhere inside the rotating shell of mass.

In other doctoral theses, books and physics articles on cavitation, light is emitted after the bubble starts to collapse. A very sharp peak of light is produced which lasts in terms of picoseconds. Thus this type of sonoluminescence is very different than the beaconing effect where the bubble remains stable for long periods of time. The beaconing effect is actually a rotating wormhole between space and hyperspace.

Briefly what happens is that there is ionized gas in the bubble which releases electrons. As the electrons spiral down through the wormhole from space into hyperspace, they give off light. This situation puts the electrons in contact with the charge of hyperspace. Space has a charge which is equal to the sum of the electron charge qₑ and the hyperspace charge qₕ. The charge of space q is equal to the Planck mass times a conversion factor between mass and charge. The Planck mass is equal to the linear mass Ω of the universe times the bottom dimensional limit of the universe known as the Planck scale Λ. The conversion factor is the square root of the gravitational constant G times the permittivity of space ε. The permittivity is linear capacitance or capacitance per unit length. Thus the charge of space is

q=ΛΩ\sqrt{Gε}=qₑ+qₕ

Because the electron comes in contact with the hyperspace charge, the drag angular velocity in the above equation has to be modified. Notice that if the angular velocity of the shell is modified by the electron fine structure constant α, and the mass involved is the mass of the electron, moving through a radius into hyperspace of the Planck scale Λ, then the drag angular velocity would be

$${ω}_{drag} = \frac{4}{3} \frac{\frac{{m}_{electron}}{Ω}}{Λ} {ω}_{shell} \frac{1}{α}$$

The angular frequency of the shell is 2π times the electron frequency fₑ.

ωₛₕₑₗₗ=ω_{electron}=2πfₑ

The inverse of the electron fine structure constant α is equal to Planck's reduced constant [symbol] times the speed of light c times the factor 4π times the permittivity of space ε divided by the square of the charge of the electron qₑ.

$$\frac{1}{α} = \frac{ℏ c 4 π ϵ}{{q}_{e}^{2}} n = 137.037916527$$

Planck's constant is equal to the Planck scale Λ squared times the linear mass Ω times the speed of light.

[symbol]

=Λ²Ωc

Notice that the fine structure constant has a square in it and Planck's constant also has a square. If the electron charge were traveling through the Planck scale into hyperspace, then there would be a linear charge equal to the electron charge divided by the Planck scale

$$\frac{1}{α} = \frac{ℏ c 4 π ϵ}{{q}_{e}^{2}} n = \frac{{Λ}^{2} Ω c c 4 π ϵ}{{q}_{e}^{2}} n = \frac{4 π Ω ϵ {c}^{2}}{{( \frac{{q}_{e}}{Λ} )}^{2}} n$$

The constant equal to the linear mass Ω times the permittivity times the square of the speed of light is actually the square of the linear charge χ of space. So the fine structure constant can be written

$$\frac{1}{α} = 4 π n \frac{{( χ )}^{2}}{{( \frac{{q}_{e}}{Λ} )}^{2}} = 4 π n \frac{{( \frac{q}{Λ} )}^{2}}{{( \frac{{q}_{e}}{Λ} )}^{2}} = 4 π {n ( \frac{q}{{q}_{e}} )}^{2} = 4 π {n ( \frac{{q}_{h} + {q}_{e}}{{q}_{e}} )}^{2} = \\ 4 π n ( \frac{{q}_{h}}{{q}_{e}} + 1 )$$

So the electron fine structure constant is related to the ratio of the charge of hyperspace to the charge of the electron, which is the reason that the equation had to be modified. The electron moving across the Planck scale wormhole is modified by the hyperspace charge it is seeing in a hyperspace co-dimension. This confirms that the beaconing effect is a rotating wormhole into hyperspace.

The electron fine structure constant is actually the fastest velocity in the Bohr atom. The fine structure constant is the ratio of the electron orbital velocity to the speed of light.

$$α = \frac{{v}_{n}}{c}$$

where the permitted quantized n orbital speeds are vₙ/n or v/1, v/2, v/3 and so on. Using a value of v/3, the fine structure constant would be

$$\frac{1}{α} = \frac{3 c}{v} = 4 π n ( \frac{{q}_{h}}{{q}_{e}} + 1 ) = 12 π ( \frac{{q}_{h}}{{q}_{e}} + 1 )$$

which when substituted into the drag angular frequency equation

$${ω}_{drag} = \frac{4}{3} \frac{\frac{{m}_{e}}{Ω}}{Λ} 2 π {f}_{e} 12 π ( \frac{{q}_{h}}{{q}_{e}} + 1 ) = 17.809 \frac{radians}{sec}$$

The frequency of precession is

$${f}_{drag} = \frac{{ω}_{drag}}{2 π} = 2.83 Hz$$

which is close to the 3 Hz observed in the experiment. The ionized electrons are moving at a slower velocity in the bubble. The 1/3 ratio could also come from the subspace tetrahedron geometry where the tetrahedral angle is determined by this ratio

θ=asin(1/3)=19.47122063°

This is an alternative possibility because this angle determines the charge of hyperspace according to the tetrahedron diagram of Δphysics. In geometrical physics, all the constants of physics are determined geometrically by the tetrahedron. The tetrahedron diagram plots the natural logarithm of mass versus the natural logarithm of wavelength. The tetrahedron is circumscribed by a sphere which reflects the electron wavelength into the electron mass. Thus the diagram combines the dual reality of classical physics, involving point mass particles, and quantum physics, involving wave-like particles. The scientific discovery that the electron and the proton are one and the same particle was made using this diagram. It also shows that hyperspace exists.

Referring to the tetrahedron diagram in FIG. 7, a line drawn at the tetrahedral angle produces the tetrahedral lines (A,B) along path (abc). This tetrahedron is circumscribed by sphere (C) with diameter (G). The electron wavelength (vertical dotted line D) reflects off the sphere (d,f) and returns as the electron mass (F). The distance (df) between reflection points is equal to the natural logarithm of the hyperspace charge. It can be shown that the electron charge is related to the geometry around the top of the sphere. Part of the geometry is outside the sphere which makes the charge immune to relativistic velocities.

Referring to FIG. 8, a current-carrying solenoid (A) produces a magnetic flux (B) through the center of the coil. The end of the solenoid behaves like a magnetic monopole. One end has a positive magnetic charge density +ρₘ and the other has a negative magnetic charge density −ρₘ. One of Maxwell's electromagnetic equations states that the divergence of the magnetic field is equal to the magnetic charge density.

∇·B=ρₘ=+ρₘ−ρₘ=0

Because the magnetic field is solenoidal, the sum of the charges in our spacetime is equal to zero, which is the usual Maxwell equation. In the case of the wormhole, one pole of the magnetic flux is in our spacetime and the other pole is in a co-dimension of hyperspace. In our universe, there is a net magnetic charge density, and Maxwell's equation becomes

∇·B=ρₘ

When working with bar magnets, bringing two north poles together shows that there is a spring constant involved. The electrons on the surface of the pole spin in the same direction which creates an electrical current around the surface. The magnetic pole strength g is therefore a spring constant K divided by the current per area J.

$$g = \frac{K}{J} ≡ \frac{kg m}{{s}^{2}} \frac{1}{m} \frac{s {m}^{2}}{q} = \frac{kg {m}^{2}}{s q}$$

The magnetic charge density is then the pole strength per volume V or

$${ρ}_{m} = \frac{g}{V} = \frac{kg {m}^{2}}{s q} \frac{1}{{m}^{3}} = \frac{kg}{m s q}$$

The divergence of the magnetic field has units of

$$∇ \cdot B = \frac{1}{m} \frac{kg}{s q}$$

which are the units of the magnetic charge density. Notice that the units can also be formatted as a pressure per electrical current in the wire.

$${ρ}_{m} = \frac{kg}{s q m} = \frac{kg m}{{s}^{2} \frac{q}{s} {m}^{2}} = \frac{force}{area} \frac{1}{I} = \frac{pressure}{current}$$

The current flowing through the coils of the solenoid, or around the pole face of the bar magnetic creates a pressure on spacetime. And it is this pressure that can punch through spacetime into hyperspace. Referring again to FIG. 8, an electrical charge winding n times around the end of the spacetime solenoid, as seen by path (C), is equal to the charge divided by Planck's constant times the pole flux

$$2 π n = \frac{q}{ℏ} {\int }_{Surface} B = \frac{q}{ℏ} Φ$$

which shows that the flux Φ is quantized by the winding number n

$$Φ = n \frac{2 π ℏ}{q} = n \frac{h}{q}$$

where the flux is equal to the winding number n times Planck's constant h divided by the charge. Since the flux is the pole strength in webers, the pole strength g has a value of

$$g = n \frac{h}{q}$$

The magnetic charge density is the pole strength divided by the Planck volume or

$${ρ}_{m} = \frac{g}{{Λ}^{3}} = n \frac{h}{q} \frac{1}{{Λ}^{3}} = n \frac{2 π {Λ}^{2} Ω c}{q {Λ}^{3}} = \frac{2 π n }{Λ} \frac{Ω c}{q} = 2 π n \frac{B}{Λ}$$

The magnetic B field of space divided by the Planck length of the wormhole, acting as a linear magnetic field, times the winding number is equal to the magnetic charge density.

Referring to FIG. 9, the wormhole (A), connecting space and hyperspace (D), is precessing (C) in the counterclockwise direction with the angular velocity vector in the vertical z-direction. The magnetic flux (B) through the wormhole is in the radial direction. The mouth of the wormhole is an area with a normal vector in the radial direction also. This arrangement creates an electric field which circulates around the interior periphery of the wormhole. Maxwell's equation says that the curl of the electric field E is equal to the negative time rate of change of the magnetic B field.

$$∇ \times E = - \frac{\partial B}{\partial t}$$

This equation is difficult to manage in differential form. As both Maxwell and Feynman have said, it is better to use the integral form involving Stokes' theorem where the area da is converted into a line integral ds which goes well with Maxwell's idea of flux linkage.

$${\int }_{surface}^{} ( ∇ \times E ) \cdot n ⅆ a = E \cdot ⅆ s = - \frac{\partial }{\partial t} {\int }_{surface}^{} B \cdot n ⅆ a = - \frac{\partial }{\partial t} Φ = - Φ {ω}_{drag}$$

The flux Φ, which is precessing around at the drag angular velocity calculated previously, is equal to the negative of the electric field around the interior perimeter (E) of the wormhole. This is the reason that the beaconing effect lasts for such a long length of time. The force on the electron is equal to the charge of the electron times the electric field. Because the charge is negative, the electron rotates counterclockwise in the opposite direction to that of the electric field. The electrons continuously circulate around the inside periphery of the wormhole. Quantum theory predicts that any radiated electromagnetic energy from an accelerated electron will give off one or more discrete quanta, or photons. The electron is accelerating because it is moving in a circular path. Because the water vapor is ionized in the cavitating bubble due to shock waves, surface oscillations and high temperatures, there are huge numbers of electrons available for producing an intense light which, as registered by the photodiode, increased by an order of magnitude when the beacon rotated by the photodiode.

From gravitational physics it is known that negative energy has to be produced in order to create a wormhole. Most experimenters are using collapsing spherical bubbles that do not produce negative energy and therefore do not produce the beaconing effect. This next background section shows that if the bubble collapses asymmetrically, then negative energy is produced.

Referring to an experiment carried out by Fizeau, FIG. 10, water flows (B,C) in opposite directions in two tubes of water (A). A light beam from a lamp (D) is projected through both tubes using half-silvered mirrors (E). Fizeau measured an interference (F) between light propagating with the flow and light swimming against the current, indicating that the flow of the medium does affect light propagation. A moving medium turns out to drag light to an extent quantified by a dragging coefficient

$$α = 1 - \frac{1}{{n}^{2}}$$

where n is the index of refraction of the medium. Einstein's addition theorem of velocities states

$$v = \frac{{v}^{′} + u}{1 + \frac{{v}^{′} u}{{c}^{2}}} = \frac{\frac{c}{n} + u}{1 + \frac{cu}{n {c}^{2}}} = \frac{\frac{c}{n} + u}{1 + \frac{u}{nc}}$$

In the limit of slow flows compared with the speed of light in a vacuum, the effective velocity of light v in the medium flowing at a velocity u is

$$v \approx ( \frac{c}{n} + u ) ( 1 - \frac{u}{nc} ) \approx \frac{c}{n} + α u$$

The relationship between cavitating bubbles and light dragging is that when the bubble collapses, the surface has a tremendous acceleration and velocity which creates internal shockwaves that bounce back and forth within the medium. At the same time, the water vapor and air are ionized which creates short bursts of light. Thus there is light that is being dragged along by the collapsing surface of the bubble. This moving medium appears to light as a change in the metric of spacetime resembling, it turns out, a gravitational field. The velocity of the medium affects the elemental length ds² of spacetime as given by the metric for light dragging

ds²=c²dt²−dx²+k(c²dt²−u·dx)²

where k is equal to

$$k = \frac{α}{{c}^{2} - {u}^{2}}$$

and dx is the elemental length in the {dx,dy,dz} directions. The velocity u in the dot product is equal to the velocities {ux,uy,uz} in the x, y and z-directions. Expanding the equation produces the following metric

ds²=(1+k)dt²+(kuₓ²−1)dx²+(ku_{y}²−1)dy²−dz²−2kuₓdxdt−2ku_{y}dydt+2kuₓu_{y}dxdy

where velocity uz is zero and the speed of light is equal to one.

The dt² energy density term is modified by one plus the k factor. Thus the index of refraction of the medium, the speed of light and the overall light dragging velocity u affects the energy density. It can be shown that the speed of light in hyperspace is much lower. The difference of the squares of the velocities in the denominator creates the possibility for amplification of this term.

The factors of the elemental lengths are then inserted into the g metric tensor which is then used to calculate the spacetime distortion generated by the collapsing bubble. The g metric tensor is a 4×4 matrix having rows and columns that correspond to the elemental lengths {t, x, y, z}.

$$\begin{matrix}β = t β = x β = y β = z \\ {g}_{α β} = \begin{matrix}α = t \\ α = x \\ α = y \\ α = z\end{matrix} ‖ \begin{matrix}1 + k & - {ku}_{x} & - {ku}_{y} & 0 \\ - {ku}_{x} & {ku}_{x}^{2} - 1 & {ku}_{x} {u}_{y} & 0 \\ - {ku}_{y} & {ku}_{x} {u}_{y} & {ku}_{z}^{2} - 1 & 0 \\ 0 & 0 & 0 & - 1\end{matrix} ‖\end{matrix}$$

In Einstein's General Theory of Relativity, the G curvature tensor, which is a 4×4 matrix having units of inverse meter squared, is equal to a stress-energy-momentum T tensor that is calculated from the electromagnetic fields. The stress tensor T combines energy density, electromagnetic flux, and pressure terms in one matrix.

G=8πT

Most of the physics constants are linear constants such as linear mass which is mass per unit length. The permittivity of space ε is linear capacitance or capacitance per meter. The permeability of space μ is linear inductance or inductance per meter. The speed of light converts time into meters. What this means is that energy, pressure and momentum can all be converted into meters using these linear constants. The inverse squared of the length in meters is the curvature which is measured in units of m⁻².

Referring to FIG. 11, a square bubble (A) in the xy plane collapses with a velocity in the x-direction (C), and a velocity in the y-direction (B). This produces a curvature in the vertical z-direction (D). The curvature in the z-direction is the curvature tensor component G_{zz}. which can be computed directly from the g light dragging metric tensor. The result of the calculation is an equation in terms of the velocity, acceleration and the time rate of change of the acceleration, known as jerk.

Because the profile of the bubble radius expanding and collapsing with time has been published by those researching cavitation, it is possible to differentiate the profile to get the velocity, acceleration and jerk. These equations can then be inserted into the equation for the G curvature tensor.

The radius R of the bubble depends on the air density inside the bubble ρ, the viscosity of the water μ, the pressure of the P of the environment, the surface tension σ of the water, the ratio of specific heats γ, and the velocity \dot{R} and acceleration \ddot{R} of the bubble radius.

$$R \ddot{R} + \frac{3}{2} \dot{R} + \frac{4 μ}{ρ} \frac{\dot{R}}{R} + \frac{2 σ}{ρ R} + \frac{{P}_{0}}{ρ} - ( {P}_{0} + \frac{2 σ}{{R}_{0}} ) {( \frac{{R}_{0}}{R} )}^{3 γ} = 0$$

Referring to FIG. 12, the above equation for the bubble radius is shown in the feedback simulation program. The diagram starts by solving the equation for the acceleration which is then integrated twice (1/S) to get the velocity and position. These variables are then fed back to the input through the various constants involving the viscosity, surface tension, pressure and air density. The graph at the bottom of the simulation shows the bubble radius with time.

Referring to FIG. 13, the bubble profile with time is reproduced from the Scientific American article mentioned previously. This profile was then fitted with a polynomial equation which is plotted in FIG. 14. By differentiating the equation, the velocity, acceleration and jerk are obtained which can then be inserted into Einstein's G curvature tensor.

Referring to FIG. 15, the curvature component in the vertical direction G_{zz} is plotted with respect to time. In the Scientific American plot, the light flash occurs at the end of the collapse marked “LIGHT FLASH” around 22 microseconds (FIG. 13). This corresponds to the two intense positive curvature G_{zz} spikes at the end of the collapse. This represents a symmetrical spherical bubble collapse where the velocities are the same in the x and y directions.

The energy density component Gₜₜ for this symmetrical collapse is given by

$${G}_{tt} = \frac{- 2 {u}_{y}^{2} {a}_{x}^{2} + 4 {u}_{x} {u}_{y} {a}_{x} {a}_{y} - 2 {u}_{x}^{2} {a}_{y}^{2}}{4 ( {u}_{x}^{2} + {u}_{y}^{2} - 2 )}$$

Looking at this carefully, notice that if the velocity in the x-direction uₓ is equal to the velocity in the y-direction u_{y}, and the acceleration in the x-direction aₓ is equal to the acceleration in the y-direction, then the equation reduces to zero.

$${G}_{tt} = \frac{- 2 {u}^{2} {a}^{2} + 4 {u}^{2} {a}^{2} - 2 {u}^{2} {a}^{2}}{8 ( {u}^{2} - 1 )} = 0$$

which means that the symmetrical collapse with equal velocities does not produce any negative energy with which to create the wormhole. Only sharp pulses of light are emitted at the end of the bubble collapse where the intense positive curvature spikes are encountered. In order to get the rotating wormhole beaconing effect, the velocities have to be different.

Referring to FIG. 16, the bubble is given an asymmetrical profile as shown by the two curves. The upper curve is in the x-direction, and the lower curve is in the y-direction. The collapse in the y-direction is not as severe.

Referring to FIG. 17, the asymmetrical collapse has the curvature spikes at the beginning similar to the symmetrical case of FIG. 15. Notice that there are no spikes at the end of the collapse. However, the energy density is much different.

Referring to FIG. 18, the energy density Gₜₜ is plotted as a function of time. Rather than being zero as in the symmetrical case, there is a large region of negative energy density as the bubble collapses. This negative energy is what creates the wormhole. Because there are no large curvature spikes at the end of the collapse, the wormhole bubble is stable and precesses for a few minutes.

Experiments with the pendulum show that some people have much larger auras than others. The pendulum swings over the entire hand. One particular person who has enormous vortices was working in a television repair shop. When a television set is brought in to the shop, the large capacitor has to be discharged first. The repairman with the large chakra vortices was standing behind a second repairman who was approaching the television set. As the second repairman got closer to the set, an enormous streaming blue spark sailed over his head and zapped the first technician. Hyperspace has a much higher permittivity than our spacetime. The resistance of space R is equal to the square root of the permeability μ over the permittivity ε.

$$R = \sqrt{\frac{μ}{ϵ}}$$

Since the technician with the large chakra vortices was producing large quantities of hyperspace energy, his resistance was very much lower due to his larger permittivity. The spark grounded on his body. The free electrons, which are created by ionization of the hydrogen atoms of the water vapor, see a very low path of resistance and flow toward the wormhole. There they are trapped in accelerated motion due to the presence of the circular electric field and give off substantial numbers of photons which produces the beaconing lighthouse effect.

The elemental length ds² in cylindrical coordinates {t, r, θ, z} for a mass M is given by

$${ds}^{2} = - \frac{{dt}^{2}}{1 - \frac{M}{r}} + ( 1 - \frac{M}{r} ) {dr}^{2} + {r}^{2} d {θ}^{2} + {dz}^{2}$$

The mass M distorts the radius r of the elemental length which is what gives the mass a curvature or gravitational field. Negative energy, which is produced at the end of the bubble collapse, is equal to a negative mass times the speed of light squared. Thus mass M in the equation goes to negative mass, or M→−M. Furthermore, negative energy inverts the mass factor so that the metric becomes

$${ds}^{2} = - ( 1 + \frac{M}{r} ) {dt}^{2} + \frac{{dr}^{2}}{1 + \frac{M}{r}} + {r}^{2} d {θ}^{2} + {dz}^{2}$$

The g metric tensor contains the factors of the elemental lengths along the matrix diagonal

$${g}_{α β} = ‖ \begin{matrix}- ( 1 + \frac{M}{r} ) & 0 & 0 & 0 \\ 0 & \frac{1}{1 + \frac{M}{r}} & 0 & 0 \\ 0 & 0 & {r}^{2} & 0 \\ 0 & 0 & 0 & 1\end{matrix} ‖$$

As before, Einstein's G curvature tensor in the radial Gᵣᵣ, angular G_{θθ}, and vertical z-direction G_{zz} is calculated from this negative energy g metric tensor.

Referring to the 3D G curvature plot in FIG. 19, the strength of the curvature is given by the length of the arrow, and the direction of the curvature is given by the arrow. The curvature in the radial direction Gᵣᵣ is along the bottom axis from the box corner origin to the right. The curvature in the angular direction G_{θθ} is the bottom axis from the origin to the left. The height of the box is the curvature in the vertical direction G_{zz}. Notice in general that the curvature is perpendicular to the left face (θz-plane) and then starts to curve to the right and begins to point toward the right face (rz-plane). On the bottom face (rθ-plane) there is an upward vertical curvature.

In cylindrical coordinates, the θz-plane is actually a vertical tube of radius r. So at small r, the curvature is perpendicular to the tube. At larger radius, the curvature starts to point in the θ-direction, wrapping around the tube. At small radius, there is also a vertical curvature parallel to the sides of the tube.

Referring to FIG. 20, the curvature in cylindrical coordinates is seen to be the structure of the wormhole. The wormhole (A) is formed due to the radial pressure (B) which pulls open the wormhole. One end of the tube connects to hyperspace, and the other end connects to our spacetime. There is also a shearing pressure (D) along the sides of the tube which slices spacetime open and helps shape the tube. Moving outward along the radius, the curvature turns sideways and produces a shearing pressure (D) in the θ-direction which gives the wormhole a vortex appearance. These wormholes can also be very large, enabling one to peer into a co-dimension as attested to by the inventor.

### SUMMARY OF THE INVENTION

As described in the previous section, the cavitating bubble has to collapse asymmetrically in order to generate the negative energy which creates the wormhole. In order to collapse asymmetrically, the forces on the bubble surface have to be unequal. The force on the bubble is given in terms of the a dragging coefficient, the bubble radius R, the surface charge density Dᵣ, the magnetic B field in spherical coordinates {Bᵣ, B_{θ}, B_{φ}}. The fields are integrated over the entire solid angle Ω of the bubble to determine the force F.

$${F}_{r} = - ( 1 - \frac{1}{{n}^{2}} ) \frac{{R}^{2}}{2} ∮ ⅆ Ω [ ( 1 + \frac{1}{{n}^{2}} ) ( {D}_{r}^{2} + {B}_{r}^{2} - {B}_{θ}^{2} - {B}_{φ}^{2} ) ]$$

The integration of the tangential components of the magnetic field such as {B_{θ}, B_{φ}} over the solid angle of the bubble will sum to zero. The surface charge density Dᵣ and the radial magnetic field Bᵣ are the only fields which can be used to create an unbalanced force. If there is no surface charge density, then the force equation reduces to

$${F}_{r} = - α \frac{{R}^{2}}{2} ∮ ⅆ Ω [ ( 2 - α ) ( \frac{{χ}^{2}}{{Ω}_{m}} {B}_{r}^{2} ) ]$$

where the conversion constant is the linear charge squared divided by the linear mass of the universe χ² /Ωₘ.

In this invention, referring to FIG. 21, the magnetic field is created by two cylindrical solenoids (A,B) which are wrapped around the top and bottom of the glass container (C). The container has flat sides in the shape of an octagon. Each solenoid consists of a continuous roll of very thin sheet copper which are separated by beaded mylar line. The mylar beads separate the sheets electrically and provide air cooling to the coil which can get rather hot. This makes it easy to assemble the coil because the copper roll and mylar line are wound together as the solenoid is formed. The lines of magnetic flux flow vertically through the container yet do not interfere with the transducers (D) which are mounted on the flat sides of the container.

Referring to FIG. 22, the cavitating bubble which forms in the liquid in the container experiences a vertical magnetic field (B) due to the two solenoids. These flux lines create a radial force on the top and bottom of the bubble (D,C). The flux lines on the outside (E) do not create any radial force because they are tangential to the surface. The spherical bubble flattens into an asymmetrical ellipsoidal shape (A) which enables the creation of the wormhole and lighthouse beaconing effect.

Referring to FIG. 23, the spacetime curvature of the wormhole (D) creates a tunnel (C), known as the throat of the wormhole, between flat space in our universe (A) and flat hyperspace (B) which exists in a co-dimension of our universe. In general, the co-dimensions have different physics constants. Going back to the chakra vortices of the human energy field, the vortices remove energy from space and deliver it to several hyperspace co-dimensions. This energy builds up human aura modules at different frequencies in astral space. Astral space has a very low speed of light and small linear mass. This is the reason that human beings can leave their bodies and pass through solid concrete walls, or project their spiritual eye to remote locations for viewing. On the other hand, the linear mass and speed of light of space is very much greater than hyperspace. Therefore, the pressure of the space is much greater than the pressure in hyperspace. In terms of the wormhole with a throat area A, the pressure would be the linear mass times the speed of light squared over the area

$${P}_{space} = \frac{{Ω}_{s} {c}_{s}^{2}}{A}$$

The pressure of hyperspace on the other side of the wormhole is

$${P}_{hyperspace} = \frac{{Ω}_{h} {c}_{h}^{2}}{A}$$

Because the linear mass and the speed of light of hyperspace are lower than that of space, there is a positive net pressure going into hyperspace.

Pₙₑₜ=P_{space}−P_{hyperspace}

This is the reason that the human vortices can obtain energy from this universe. Because the cavitating bubble produces negative energy, the linear mass is negative on the side of space. The pressure equation is then given by

$${P}_{net} = - \frac{{P}_{s}}{A} - \frac{{P}_{h}}{A} = - \frac{{P}_{s} + {P}_{h}}{A}$$

which shows that there is a reverse pressure going from hyperspace into our space. The asymmetrical cavitating bubble generates hyperspace energy. The hyperspace energy flowing into our universe also gives the light generated by the wormhole a soft white misty look.

There are many reasons for generating this hyperspace energy. Electromagnetic fields are subject to the Lorentz transformation which involves comparing the frame velocity with that of the velocity of light.

$${E}^{′} = \frac{E}{\sqrt{1 - \frac{{v}^{2}}{{c}^{2}}}}$$

If the ratio of the velocity v to the velocity of light c is close to unity, then huge relativistic fields can be produced. These fields can curve spacetime to such an extent that a large lift force can be produced on the hull of an electromagnetic field propulsion vehicle.

### STATEMENT REGARDING FEDERALLY SPONSORED RESEARCH OR DEVELOPMENT

Not Applicable.

### A BRIEF DESCRIPTION OF THE DRAWINGS

FIG. 1. Rotating cylinder demonstrating additional lift force.

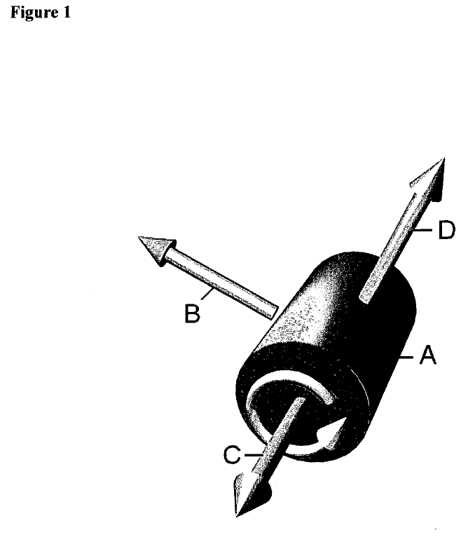

FIG. 2. Use of the pendulum.

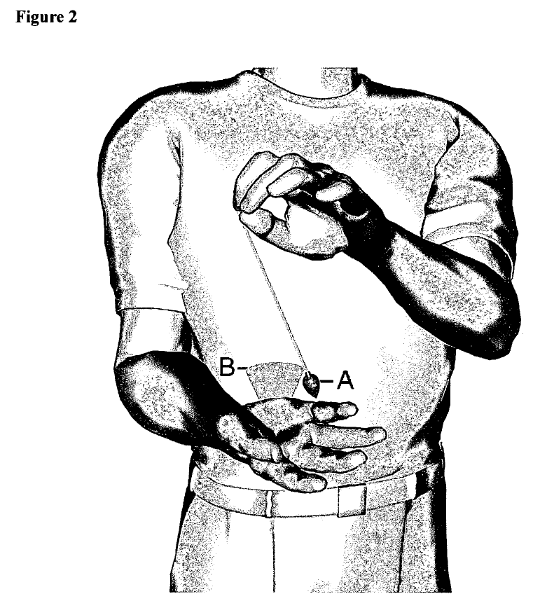

FIG. 3. The Ascension Machine, Chakra Vortex Accelerator.

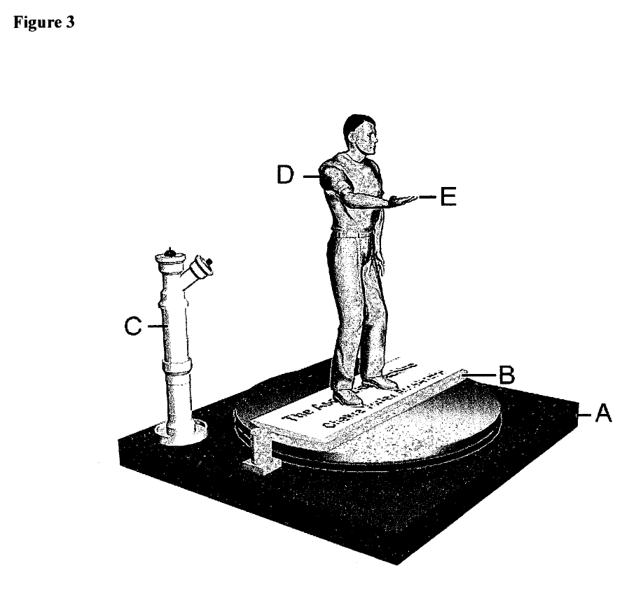

FIG. 4. Hyperspace energy brought into body by rotation of hand chakra.

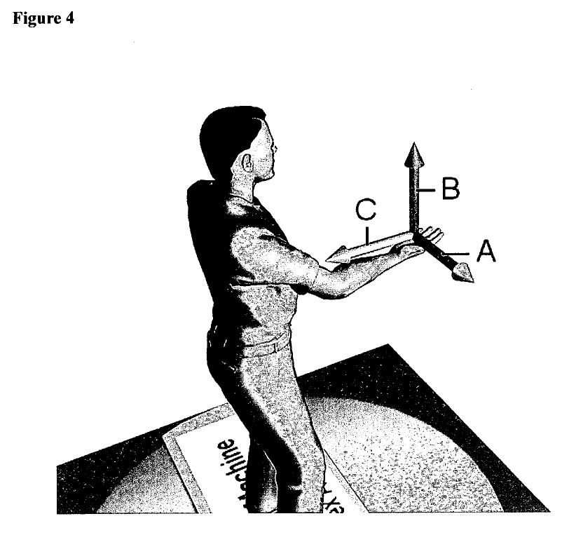

FIG. 5. Antigravitational effect using low density hyperspace energy.

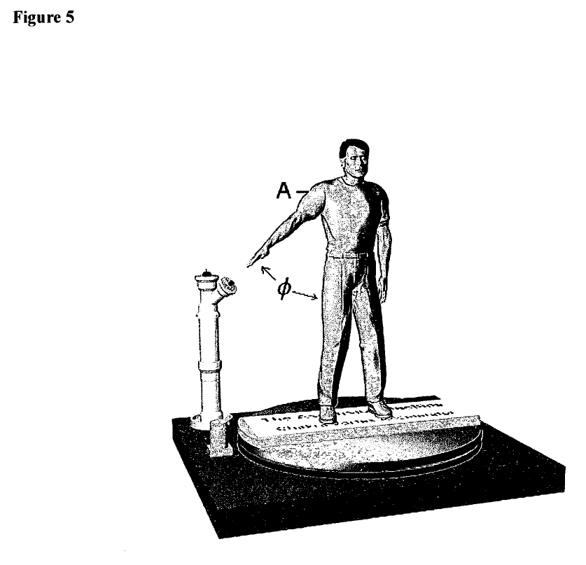

FIG. 6. Sonoluminescence experiment.

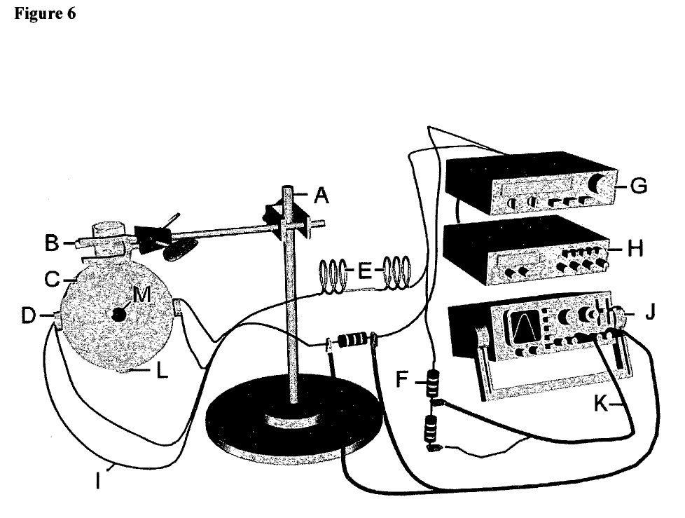

FIG. 7. Tetrahedron diagram showing hyperspace charge.

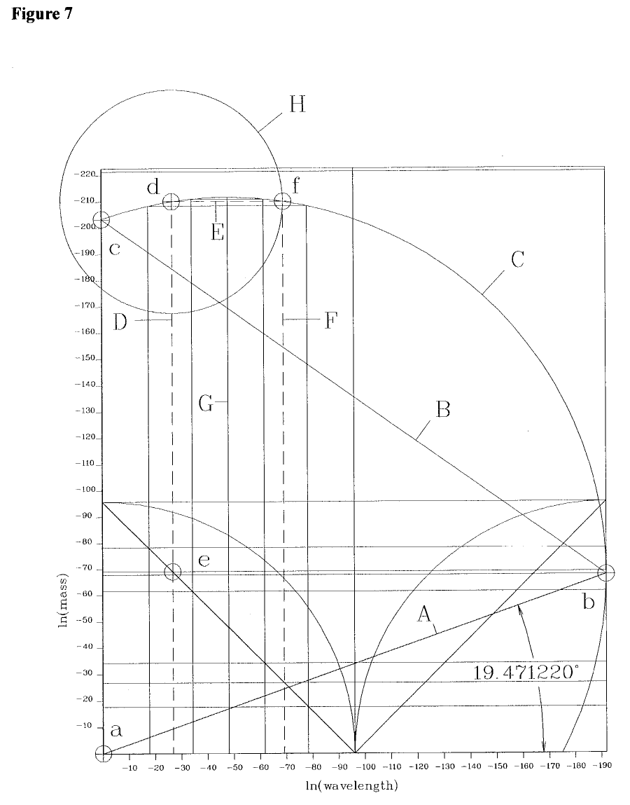

FIG. 8. Magnetic monopole.

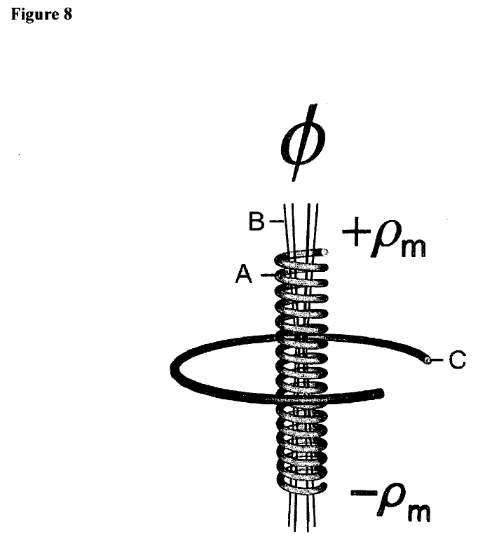

FIG. 9. Precessing wormhole.

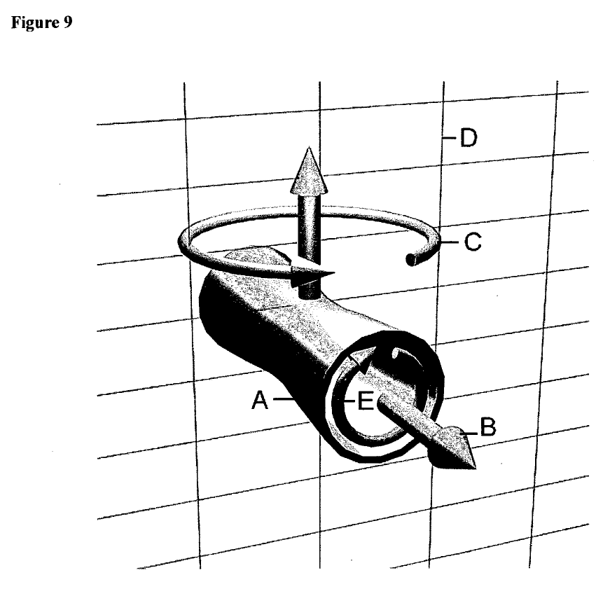

FIG. 10. Fizeau light dragging experiment.

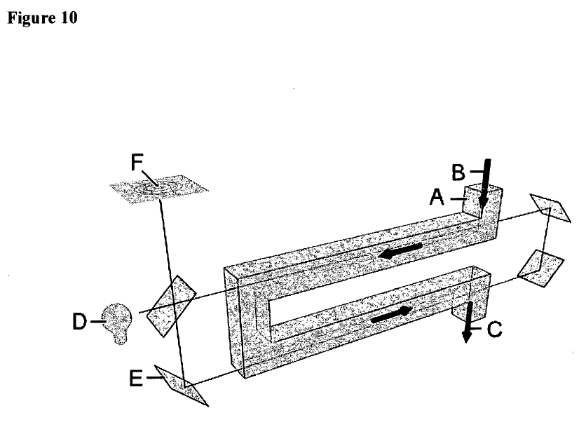

FIG. 11. Asymmetrical velocity collapse of bubble radius generates wormhole.

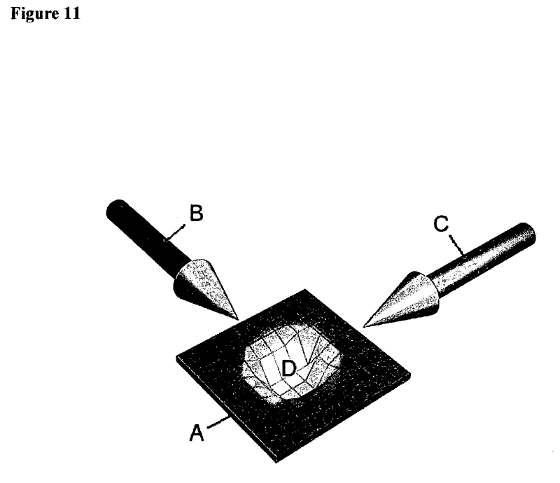

FIG. 12. VisSim feedback simulation of the collapsing bubble.

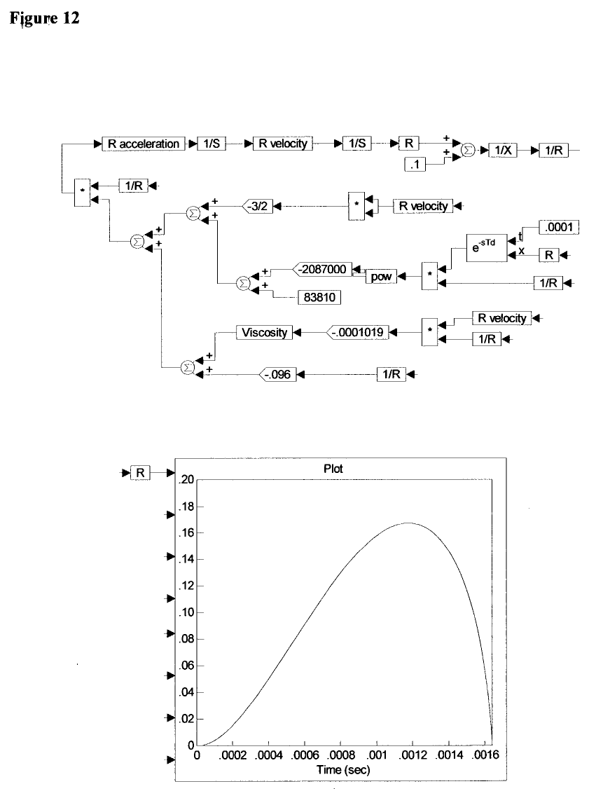

FIG. 13. Cavitating bubble radius as a function of time.

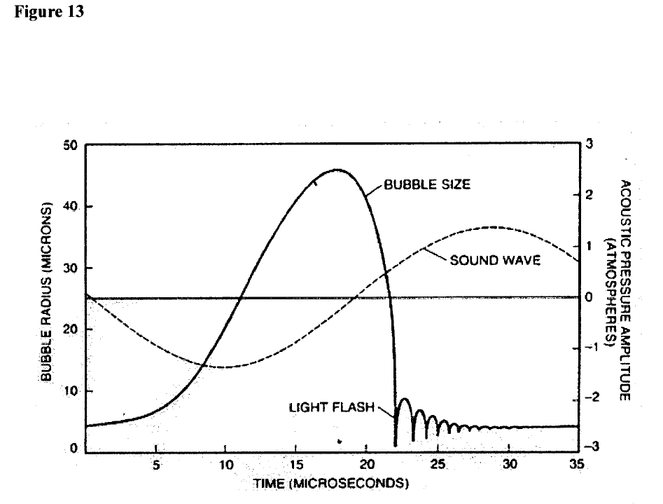

FIG. 14. Digitized bubble radius of FIG. 13.

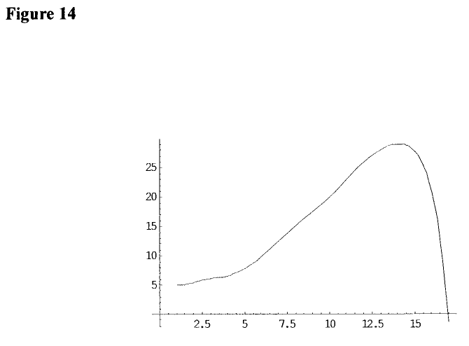

FIG. 15. Spiking spacetime curvature of collapsing bubble.

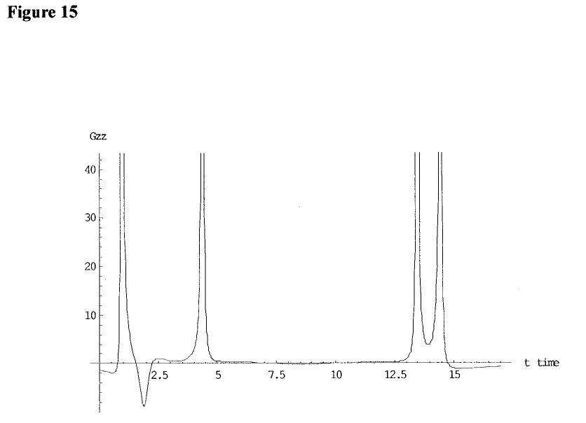

FIG. 16. Dual velocity profile required to produce negative energy.

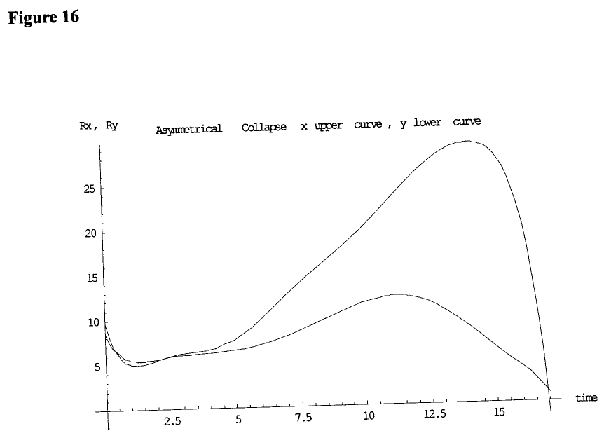

FIG. 17. Spacetime curvature for dual velocity collapse.

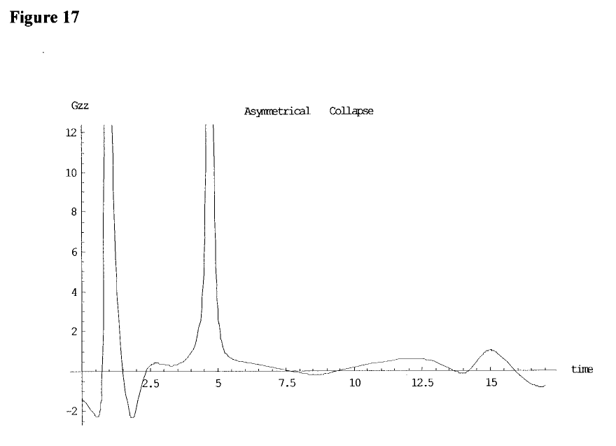

FIG. 18. Negative energy generated from asymmetrical collapse of bubble.

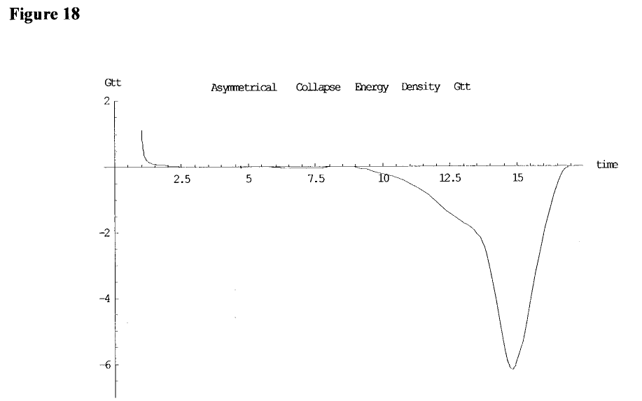

FIG. 19. 3D plot of spacetime curvature using negative energy.

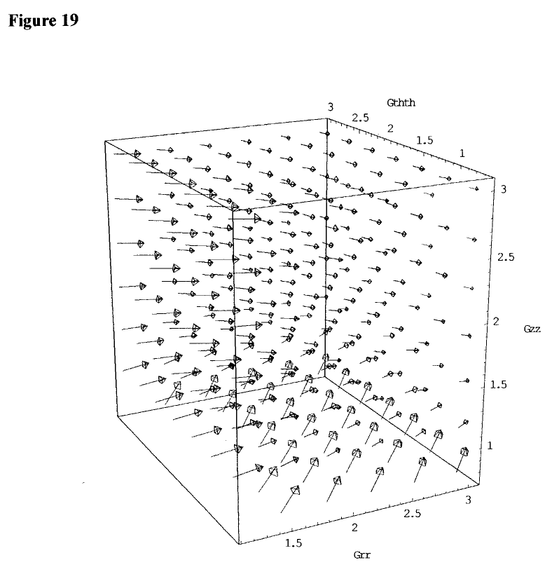

FIG. 20. Wormhole vortex.

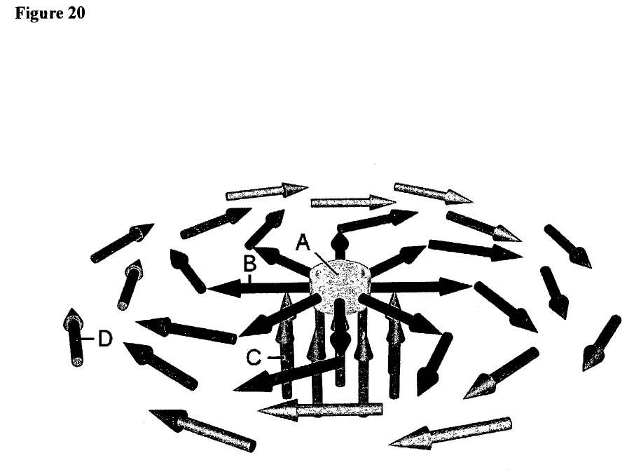

FIG. 21. Perspective of cavitation tank equipped with magnetic coils.

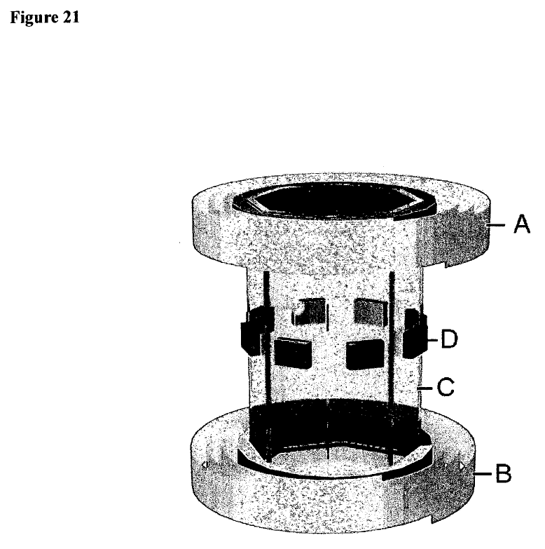

FIG. 22. Flattening of bubble by magnetic field.

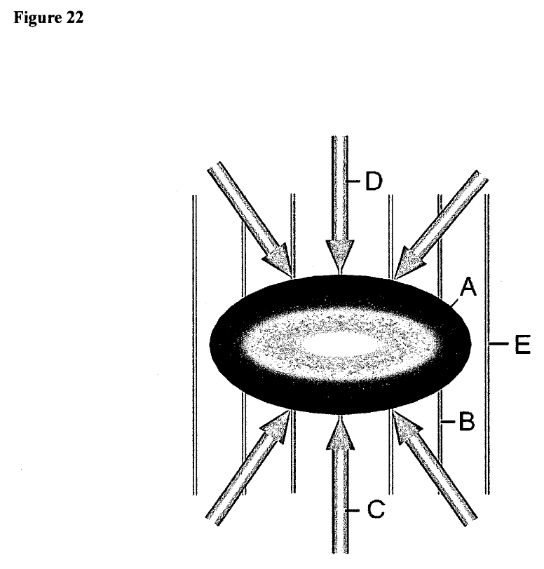

FIG. 23. Hyperspace energy generated by reverse pressure gradient of wormhole.

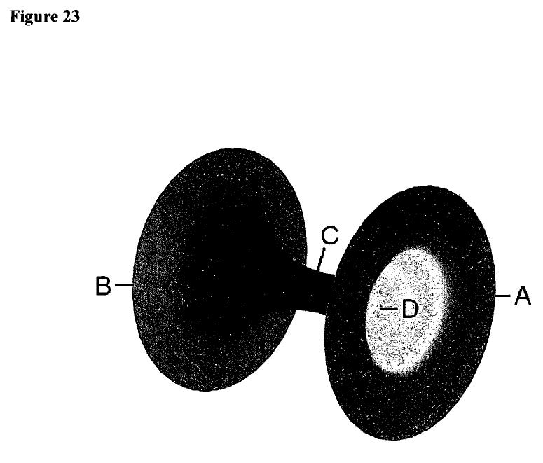

FIG. 24. Solenoid and transducer driving circuits.

### DETAILED DESCRIPTION OF THE INVENTION

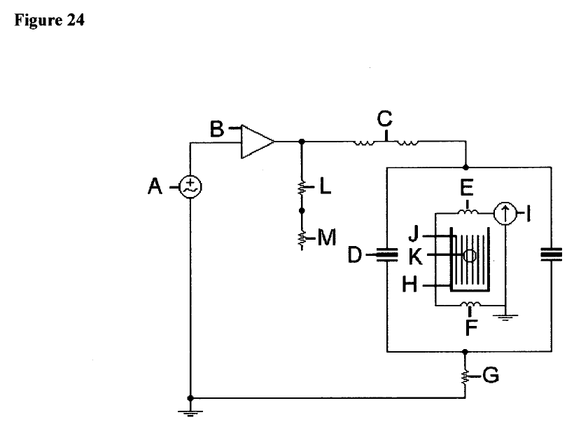

1. Referring to FIG. 24, the transducer driving circuit uses a frequency generator (A) driving a linear amplifier (B) into a pair of variable inductors (C) which resonate with the capacitance of the transducers (D) attached to the sides of the octagonally-shaped glass container (H). Resistors (L,M,G) provides voltage measuring points for the oscilloscope.

A DC current source (I) drives the two solenoids (E,F) which produce a vertical magnetic field (J) through the container. The magnetic field produces an asynmetrical force on the bubble surface (K) such that the collapsing bubble produces negative energy. The spacetime curvature produced by the light dragging of the collapsing bubble surface, together with the negative energy, create a wormhole between space and hyperspace. The negative spacetime energy produces a negative pressure which brings low-density hyperspace energy into our dimension.

I claim:

1. A hyperspace energy generator having:
a) a glass container in the shape of an octagon acting as the resonating chamber;
b) two piezoelectric transducers, mounted and operating acoustically as a pair on opposite sides of item (1a);
c) an opaque oil-like liquid with a high index of refraction filling item (1a) acting as the resonating liquid in which the cavitating bubbles are formed;
d) two thin sheet copper solenoids, located on top and bottom of item (1a), that produce a vertical magnetic field through items (1a) and (1c);
e) two variable inductance coils for creating a resonant frequency with item (1b);
f) a linear amplifier driving items (1b) and (1e);
g) a variable frequency generator driving item (1e);
h) a direct current electrical generator driving item (1d);

2. a cavitation system which:
a) produces one or more cavitating bubbles that collapse asymmetrically due to the differential force exerted on the bubble surface by the presence of a vertical magnetic field generated by item (1d) referred to above;
b) generates negative energy due to light dragging of the collapsing bubble surface;
c) creates wormholes between space and hyperspace due to the presence of item (1b);
d) generates a negative pressure between space and hyperspace that forces low-density hyperspace energy into our dimension; and

3. optional dual electrically-charged plates that:
a) are mounted on the sides of item (1a);
b) create a differential electric charge density across the bubble surface for the purpose of creating an additional method of asymmetrical bubble surface collapse.
